(19) United States
(12) Patent Application Publication
(10) Pub. No.: US 2016/0092637 A1
(43) Pub. Date: Mar. 31, 2016

(54) MEDICAL ASSISTANCE DEVICE, MEDICAL ASSISTANCE SYSTEM, MEDICAL ASSISTANCE PROGRAM, AND MEDICAL ASSISTANCE METHOD

(71) Applicant: FUJIFILM Corporation, Tokyo (JP)

(72) Inventors: Yuya KUDO, Tokyo (JP); Satoshi UEDA, Tokyo (JP); Hironori MATSUMASA, Tokyo (JP); Ryosuke USAMI, Tokyo (JP); Takamasa YAGUCHI, Tokyo (JP); Yasunori OHTA, Tokyo (JP)

(21) Appl. No.: 14/849,608

(22) Filed: Sep. 10, 2015

(30) Foreign Application Priority Data
Sep. 30, 2014 (JP) 2014-202651

(51) Int. Cl. G06F 19/00; G06Q 10/10

(52) U.S. Cl. CPC G06F 19/327; G06Q 10/1095

(57) ABSTRACT

A medical assistance server generates a medical assistance screen, and distributes the medical assistance screen to a client terminal. The medical assistance screen includes a medical schedule display region where a medical schedule is displayed and a relevant information display region where relevant information is displayed. In the medical schedule display region, a medical schedule in which medical acts are arranged in time series is displayed, so that one of the displayed medical acts can be selected. In the relevant information display region, various kinds of information that are referred to when performing the medical act selected in the medical schedule display region are displayed. The user can perform a medical examination by referring to the schedule and the relevant information.

### CROSS-REFERENCE TO RELATED APPLICATIONS

The present application claims priority under 35 U.S.C. §119 to Japanese Patent Application No. 2014-202651, filed on Sep. 30, 2014, all of which are hereby expressly incorporated by reference into the present application.

### BACKGROUND OF THE INVENTION

1. Field of the Invention

The present invention relates to a medical assistance device and system to assist a medical examination, a non-transitory computer-readable recording medium on which a medical assistance program is recorded, and a medical assistance method.

2. Description of the Related Art

In the medical field, various kinds of medical computer systems for assisting a medical examination have been proposed. As one of the medical computer systems, JP2014-063214A discloses a medical assistance system that automatically creates and displays a subsequent medical schedule when the symptoms or the like of the patient are set. The medical schedule is a medical plan in which a plurality of medical acts performed on a patient, specifically, medical acts, such as diagnosis, examination, treatment, surgery, and their preparatory acts, for a patient are arranged along the time axis. In the medical schedule, the time or the order of performing a medical act is defined. By creating a medical schedule, the content of the medical schedule can be shared among the medical staff, such as doctors and nurses.

### SUMMARY OF THE INVENTION

However, in order to provide adequate medical assistance, there has been a demand to be able to refer to a larger amount of information relevant to the medical schedule in addition to the medical schedule disclosed in JP2014-063214A. For example, from the medical schedule, it is possible to check the execution order of medical acts. However, when executing each medical act in practice, it is necessary to refer to relevant information (vital information, such as body temperature, blood pressure, and electrocardiogram, and matters for attention (for example, notes) at the time of medical examination) corresponding to the medical act to be executed. The medical assistance system disclosed in JP2014-063214A has only a function of creating a medical schedule. In this case, it is possible to reduce the time and effort to create a medical schedule. However, when performing the medical examination in practice, the relevant information described above should be separately collected, and this takes time and effort.

The invention has been made in view of the above background, and it is an object of the invention to provide a medical assistance device and system capable of easily providing a more extensive medical assistance, a non-transitory computer-readable recording medium on which a medical assistance program is recorded, and a medical assistance method.

In order to achieve the above-described object, according to an aspect of the invention, there is provided a medical assistance device including: an output control unit that outputs a medical assistance screen including a medical schedule display region, in which a medical schedule that is plurality of medical acts performed on a patient are arranged along a time axis is displayed, and a relevant information display region, in which relevant information that is relevant to the medical acts is displayed; an operation instruction receiving unit that receives a selection operation instruction to select one of the plurality of medical acts included in the medical schedule in the medical schedule display region; a correspondence relationship reading unit that accesses a storage unit, in which a correspondence relationship between each of the plurality of medical acts and relevant information corresponding to each medical act is stored, to read a correspondence relationship regarding a medical act selected by the selection operation instruction; and a screen data editing unit that acquires the relevant information of the selected medical act based on the correspondence relationship read by the correspondence relationship reading unit and displays the acquired relevant information in the relevant information display region.

In the medical assistance device according to the aspect of the invention, the relevant information may include at least either vital information of a patient or attention information to be noted when performing each of the medical acts.

In the medical assistance device according to the aspect of the invention, the attention information may include at least either notes when performing each of the medical acts or branching conditions when a route of the medical schedule branches.

The medical assistance device according to the aspect of the invention may further include an automatic selection unit that automatically selects one of the medical acts in the medical schedule when there is no input of the selection operation instruction, and the correspondence relationship reading unit may read the correspondence relationship regarding the medical act selected by the automatic selection unit.

The medical assistance device according to the aspect of the invention may further include a data editing unit that edits the correspondence relationship stored in the storage unit based on a data editing request.

In the medical assistance device according to the aspect of the invention, not only the correspondence relationship but also a layout for displaying the relevant information in the relevant information display region may be stored in the storage unit, and the screen data editing unit may edit the relevant information display region based on the correspondence relationship and the layout.

In the medical assistance device according to the aspect of the invention, as a display form of the relevant information, at least one of characters, numbers, a still image, a moving image, a graph, and a table may be included.

In order to achieve the above-described object, according to another aspect of the invention, there is provided a medical assistance system including: a client terminal; and a medical assistance device that assists a medical act based on a request input from the client terminal, in which the medical assistance device includes: an output control unit that outputs a medical assistance screen including a medical schedule display region, in which a medical schedule that is plurality of medical acts performed on a patient are arranged along a time axis is displayed, and a relevant information display region, in which relevant information that is relevant to the medical acts is displayed; an operation instruction receiving unit that receives a selection operation instruction to select one of the plurality of medical acts included in the medical schedule in the medical schedule display region; a correspondence relationship reading unit that accesses a storage unit, in which a correspondence relationship between each of the plurality of medical acts and relevant information corresponding to each medical act is stored, to read a correspondence relationship regarding a medical act selected by the selection operation instruction; and a screen data editing unit that acquires the relevant information of the selected medical act based on the correspondence relationship read by the correspondence relationship reading unit and displays the acquired relevant information in the relevant information display region.

In order to achieve the above-described object, according to still another aspect of the invention, there is provided a medical assistance program causing a computer as a medical assistance device for assisting a medical act to execute: an output control step that outputs a medical assistance screen including a medical schedule display region, in which a medical schedule that is plurality of medical acts performed on a patient are arranged along a time axis is displayed, and a relevant information display region, in which relevant information that is relevant to the medical acts is displayed; an operation instruction receiving step that receives a selection operation instruction to select one of the plurality of medical acts included in the medical schedule in the medical schedule display region; a correspondence relationship reading step that accesses a storage unit, in which a correspondence relationship between each of the plurality of medical acts and relevant information corresponding to each medical act is stored, to read a correspondence relationship regarding a medical act selected by the selection operation instruction; and a screen data editing step that acquires the relevant information of the selected medical act based on the correspondence relationship read in the correspondence relationship reading step and displaying the acquired relevant information in the relevant information display region.

In order to achieve the above-described object, according to still another aspect of the invention, there is provided a medical assistance method including: an output control step that outputs a medical assistance screen including a medical schedule display region, in which a medical schedule that is plurality of medical acts performed on a patient are arranged along a time axis is displayed, and a relevant information display region, in which relevant information that is relevant to the medical acts is displayed; an operation instruction receiving step that receives a selection operation instruction to select one of the plurality of medical acts included in the medical schedule in the medical schedule display region; a correspondence relationship reading step that accesses a storage unit, in which a correspondence relationship between each of the plurality of medical acts and relevant information corresponding to each medical act is stored, to read a correspondence relationship regarding a medical act selected by the selection operation instruction; and a screen data editing step that acquires the relevant information of the selected medical act based on the correspondence relationship read in the correspondence relationship reading step and displaying the acquired relevant information in the relevant information display region, in which all of the above steps are executed by a medical assistance device.

In the invention, since the relevant information that is relevant to the medical acts included in the medical schedule is displayed on the same screen as the medical schedule, it is possible to easily provide a more extensive medical assistance than in the related art.

### BRIEF DESCRIPTION OF THE DRAWINGS

FIG. 1 is an explanatory diagram showing the configuration of a medical assistance system.

FIG. 2 is an explanatory diagram showing the content of a medical record DB.

FIG. 3 is an explanatory diagram showing the content of an image DB.

FIG. 4 is an explanatory diagram showing the content of a schedule DB.

FIG. 5 is an explanatory diagram showing the content of correspondence information.

FIG. 6 is an explanatory diagram showing the content of layout information.

FIG. 7 is a block diagram showing the electrical configuration of a computer that is used as a medical assistance server or the like.

FIG. 8 is an explanatory diagram showing the functional overview of a client terminal.

FIG. 9 is an explanatory diagram showing a medical assistance screen.

FIG. 10 is an explanatory diagram showing relevant information displayed in a relevant information display region.

FIG. 11 is an explanatory diagram showing relevant information displayed in a relevant information display region.

FIG. 12 is an explanatory diagram showing the functional overview of a medical assistance server.

FIG. 13 is a flowchart showing the schematic procedure of display and editing of a medical assistance screen.

FIG. 14 is an explanatory diagram showing the content of a screen generation DB.

FIG. 15 is an explanatory diagram showing the content of a screen generation DB.

FIG. 16 is an explanatory diagram showing a state in which a blood pressure change is displayed in a table form.

FIG. 17 is an explanatory diagram showing a state in which a blood pressure change is displayed in a graph form.

FIG. 18 is an explanatory diagram showing the functional overview of a medical assistance server.

FIG. 19 is an explanatory diagram showing the functional overview of a client terminal.

### DESCRIPTION OF THE PREFERRED EMBODIMENTS

### First Embodiment

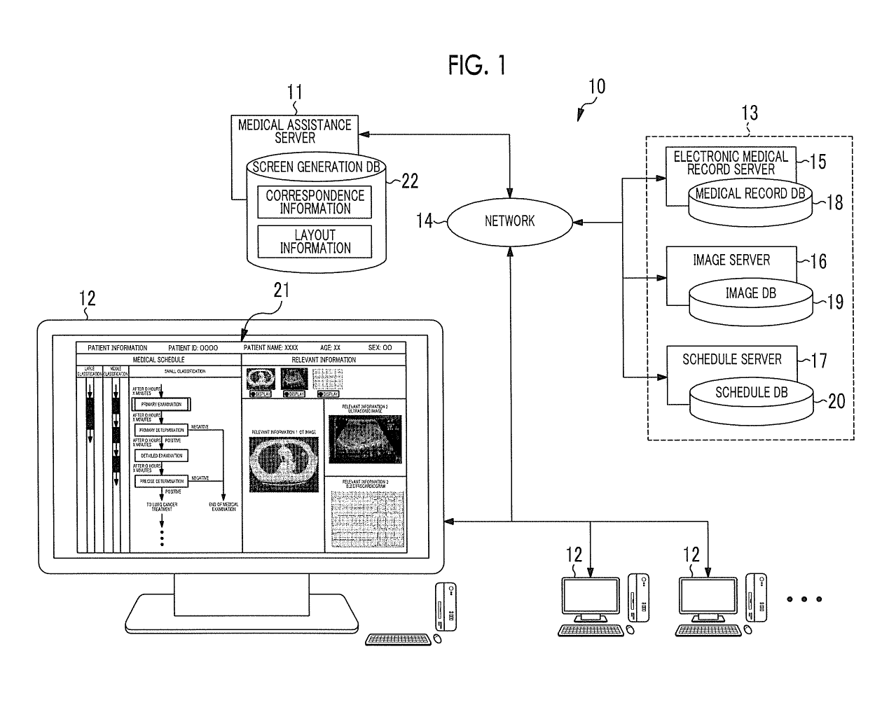

A medical assistance system 10 shown in FIG. 1 is a computer system used to assist medical acts performed in medical facilities, such as a hospital. The medical assistance system 10 consists of a medical assistance server 11, a client terminal 12, a server group 13, and a network 14 that communicably connects these to each other. The network 14 is a local area network (LAN) provided in the hospital, for example.

The server group 13 includes an electronic medical record server 15, an image server 16, a schedule server 17, and the like. The electronic medical record server 15 includes an electronic medical record database (hereinafter, referred to as an electronic medical record DB) 18. The image server 16 is a so-called picture archiving and communication system (PACS) server, and has an image database (hereinafter, referred to as an image DB) 19. The schedule server 17 includes a schedule database (hereinafter, referred to as a schedule DB) 20. The medical record DB 18, the image DB 19, and the schedule DB 20 are databases in which a search using a keyword, such as patient identification data (ID), is possible, for example.

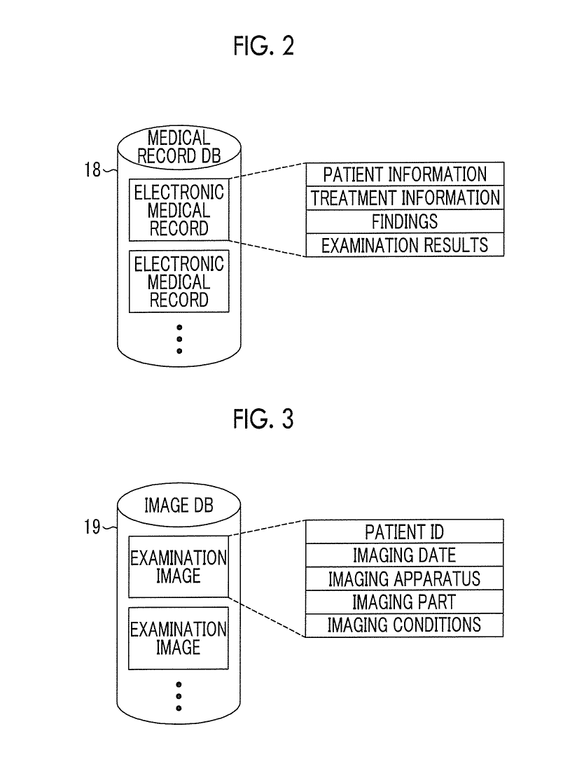

As shown in FIG. 2, a plurality of electronic medical records are stored in the medical record DB 18. Electronic medical records are provided for each patient, and include patient information, medical information, findings, and examination results. The medical information includes medical records, such as interviews, examinations, and diagnoses, and treatment records, such as treatment and surgery. The patient information includes a patient ID, a patient's name, age, sex, and the like.

Attention information including notes when performing a medical act is included in the findings. For example, notes include not only a note indicating high blood pressure or contraindication information at the time of dosing but also information, such as the treatment content and results in similar cases. In addition, the attention information also includes branching conditions. Branching means branching from a route in a medical schedule, for example. For example, in a medical schedule, the route differs depending on the examination result (for example, a medical act performed when the examination result is good is different from a medical act performed when the examination result is not preferable). The branching conditions are conditions for determining a route at the branching point of a plurality of routes. Thus, if a medical act at the branching point is an examination, the examination result becomes the branching conditions.

Vital information (for example, body temperature, blood pressure, pulse, and electrocardiogram) of a patient is included in the examination result. When an image (examination image) is included in an examination result, address information indicating the reference destination (storage destination) of the examination image is also included in the examination result.

These pieces of information, such as medical records, findings, or examination results stored in the medical record DB 18, are relevant information that is relevant to the medical act in the medical facility. The relevant information is referred to when performing the medical act.

As shown in FIG. 3, examination images captured by image examinations, such as X-ray examinations or CT examinations, are stored in the image DB 19. A patient ID, an imaging date, an imaging apparatus, an imaging part, imaging conditions, and the like are added to the examination image. In addition, similar to the data stored in the medical record DB 18 described above, examination images and various kinds of information added to the examination images, which are stored in the image DB 19, are relevant information that is relevant to a medical act, and are referred to when performing the medical act.

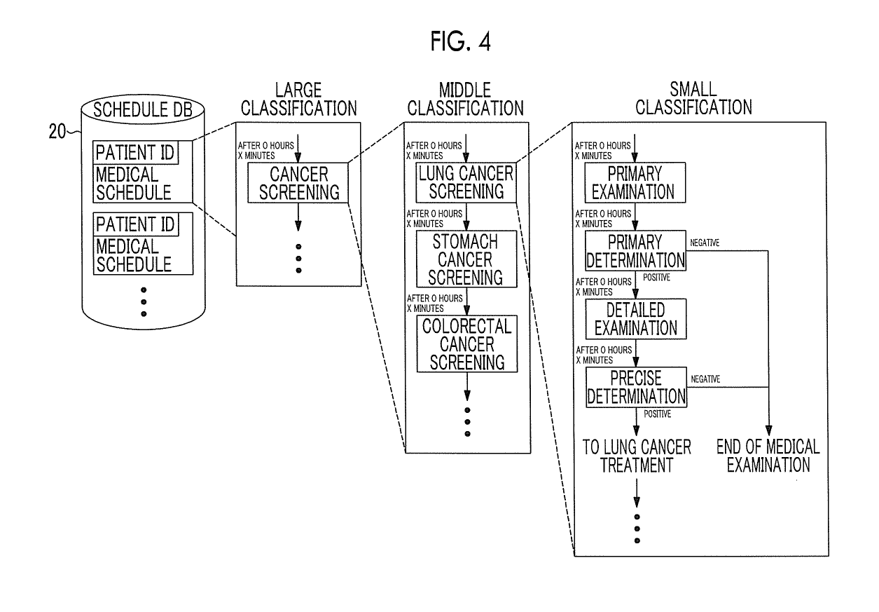

As shown in FIG. 4, a plurality of medical schedules are stored in the schedule DB 20. A medical schedule is provided for each patient, and a patient ID is added to each medical schedule. In the medical schedule, a plurality of medical acts performed on a patient are arranged in order of being put into practice along the time axis. In the example shown in FIG. 4, the medical schedule of “cancer screening” is shown.

As shown in FIG. 4, “cancer screening” includes the screening of a plurality of organs. In the “cancer screening”, a plurality of kinds (in this example, three kinds) of cancer screening, such as “lung cancer screening”, “stomach cancer screening”, and “colorectal cancer screening”, are included. In addition, various kinds of cancer screening are realized by a plurality of medical acts, such as “primary examination (blood test)” and “detailed examination (CT examination, endoscopy)”.

In this example, since a plurality of kinds of cancer screening are included in the “cancer screening”, the “cancer screening” corresponds to the medical act of a large classification, and a medical schedule including the medical act of the large classification as a component is assumed to be a medical schedule of the large classification. Various kinds of cancer screening, such as “lung cancer screening”, “stomach cancer screening”, and “colorectal cancer screening”, correspond to medical acts of a middle classification, and a medical schedule including the medical acts of the middle classification as components is assumed to be a medical schedule of the middle classification. In addition, a plurality of medical acts that form various kinds of cancer screening correspond to medical acts of a small classification, and a medical schedule including the medical acts of the small classification as components is assumed to be a medical schedule of the small classification.

Referring to FIG. 4, in the medical schedule of this example, being performed in order of “lung cancer screening”, “stomach cancer screening”, and “colorectal cancer screening” in various kinds of cancer screening of the middle classification is defined. In addition, in various kinds of cancer screening, the main route is a route in which “primary examination”, “primary determination”, “detailed examination”, and “precise determination” are performed in this order. Each of “primary determination” and “precise determination” is a branching point. Depending on the result of “primary determination” and “precise determination”, the process proceeds to the sub-route that is different from the main route.

Specifically, when negative determination is made in the “primary determination”, the process proceeds to a sub-route from the main route. In this case, the lung cancer screening is ended without performing the “detailed examination” of the main route. On the other hand, when positive determination is made in the “primary determination”, the process proceeds along the main route, and the “detailed examination” that is the next medical act is performed. After the “detailed examination”, when negative determination is made in the “detailed determination”, the process proceeds to the sub-route to end the lung cancer screening without performing the subsequent medical acts. When positive determination is made in the “precise determination”, the process proceeds to “lung cancer treatment”, which is the next medical act, along the main route.

Returning to FIG. 1, the client terminal 12 is a terminal installed in each department, such as internal medicine, surgery, otolaryngology, and ophthalmology, and is operated by the doctor of each department. The client terminal 12 has a function of accessing the electronic medical record server 15 to generate (input) or view (display) electronic medical records. In addition, the client terminal 12 has a function of accessing the image server 16 in order to show an examination image. In addition, the client terminal 12 has a function of accessing the schedule server 17 in order to generate or show the medical schedule.

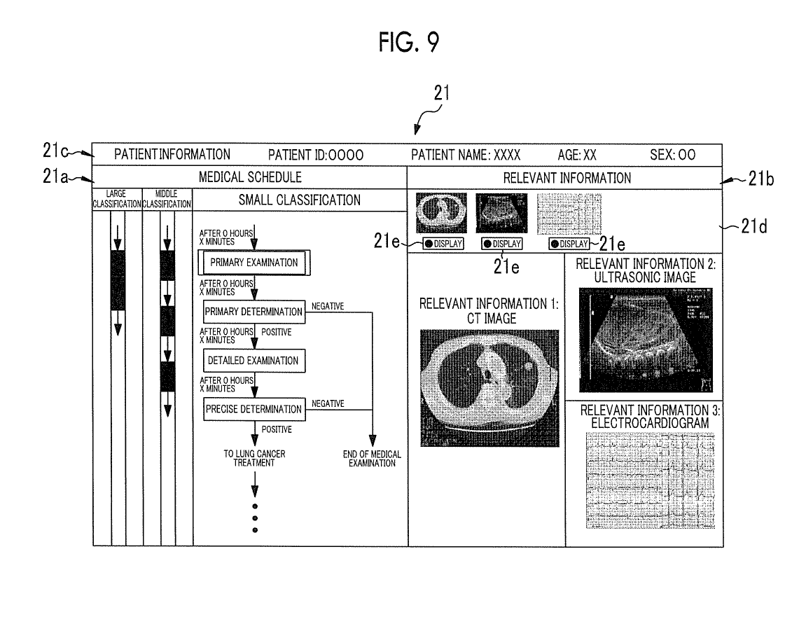

The client terminal 12 has a function of accessing the medical assistance server 11 to view a medical assistance screen 21 (refer to FIG. 9) or input various operation instructions (requests). The medical assistance screen 21 is a screen for assisting the medical act, and includes a medical schedule display region 21a to display a medical schedule and a relevant information display region 21b to display relevant information that is relevant to the selected medical act of the medical acts that are components of the medical schedule displayed in the medical schedule display region 21a.

The medical assistance server 11 is a medical assistance device of the invention that generates and edits the medical assistance screen 21 based on the request from the client terminal 12 and distributes the edited medical assistance screen 21 to the client terminal 12. A screen generation DB 22 (storage unit of the invention; hereinafter, referred to as a screen generation DB) in which correspondence information and layout information used when generating the medical assistance screen 21 are stored is provided in the medical assistance server 11.

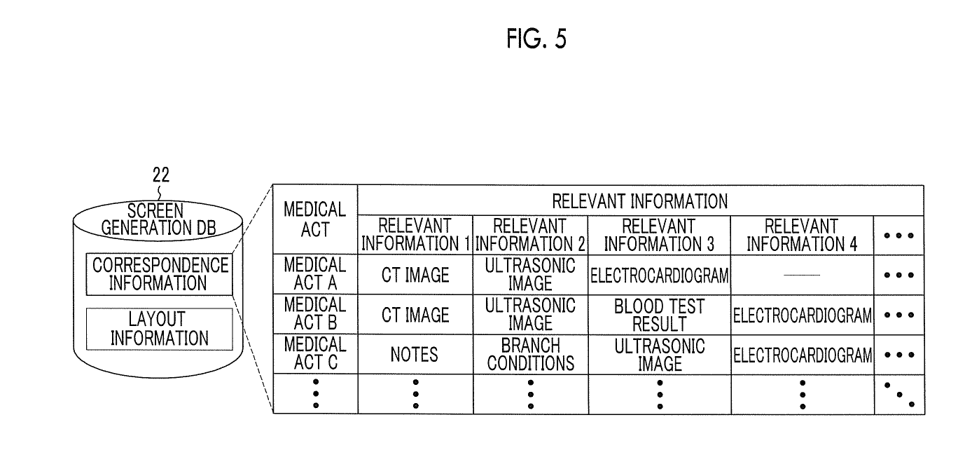

As shown in FIG. 5, the correspondence information indicates the correspondence relationship between each medical act and the relevant information corresponding to each medical act. In the example shown in FIG. 5, relevant information 1 to relevant information 3 are matched as the relevant information of a medical act A. In the medical act A, the relevant information 1 is a “CT image (examination image obtained by CT examination)”, the relevant information 2 is an “ultrasonic image (examination image obtained by ultrasonic examination)”, and the relevant information 3 is “electrocardiogram”. In addition, relevant information 1 to relevant information 4 are matched as the relevant information of a medical act B. In the medical act B, the relevant information 1 is a “CT image”, the relevant information 2 is an “ultrasonic image”, the relevant information 3 is a “result of blood test”, and the relevant information 4 is “electrocardiogram”. In addition, relevant information 1 to relevant information 4 are matched as the relevant information of a medical act C. In the medical act C, the relevant information 1 is an “ultrasonic image”, the relevant information 2 is “notes”, the relevant information 3 is “branching conditions”, and the relevant information 4 is “electrocardiogram”. “Notes” and “branching conditions” are text data included in each of findings.

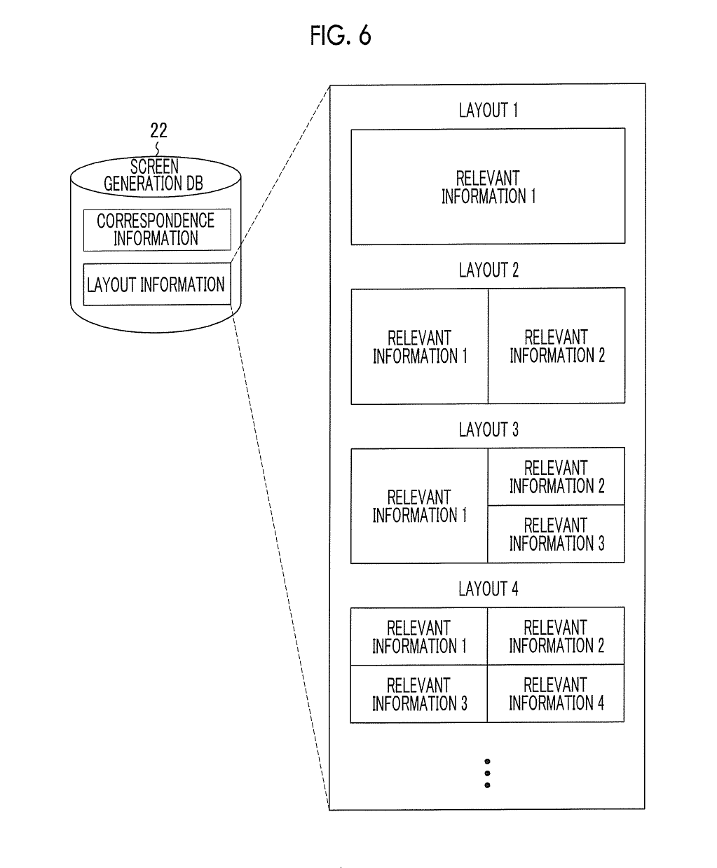

As shown in FIG. 6, layout information is information that defines the position, size, and number to display the relevant information in the relevant information display region.

In the example shown in FIG. 6, a plurality of kinds of layouts 1, 2, 3, 4, . . . set in advance are included in the layout information. For example, the layout 1 is a layout that is selected when the number of pieces of relevant information is one. In the layout 1, the relevant information 1 is displayed using the entire area of the relevant information display region 21b. The layout 2 is a layout that is selected when the number of pieces of relevant information is two. In the layout 2, the relevant information display region 21b is divided into two left and right parts. The relevant information 1 is displayed in the left region, and the relevant information 2 is displayed in the right region.

The layout 3 is a layout that is selected when the number of pieces of relevant information is three. In the layout 3, the relevant information display region 21b is divided into two left and right parts, and the right part is further divided into two upper and lower parts. The relevant information 1 is displayed in the left region, the relevant information 2 is displayed in the upper right region, and the relevant information 3 is displayed in the lower right region. The layout 4 is a layout that is selected when the number of pieces of relevant information is four. In the layout 4, the relevant information display region 21b is divided into four upper, lower, left, and right regions. The relevant information 1 is displayed in the upper left region, the relevant information 2 is displayed in the upper right region, the relevant information 3 is displayed in the lower left region, and the relevant information 4 is displayed in the lower right region.

The medical assistance server 11, the client terminal 12, and the electronic medical record server 15, the image server 16, and the schedule server 17 that form the server group 13 are configured by installing a control program, such as an operating system, or an application program, such as a client program or a server program, into a computer as a base, such as a personal computer, a server computer, or a workstation.

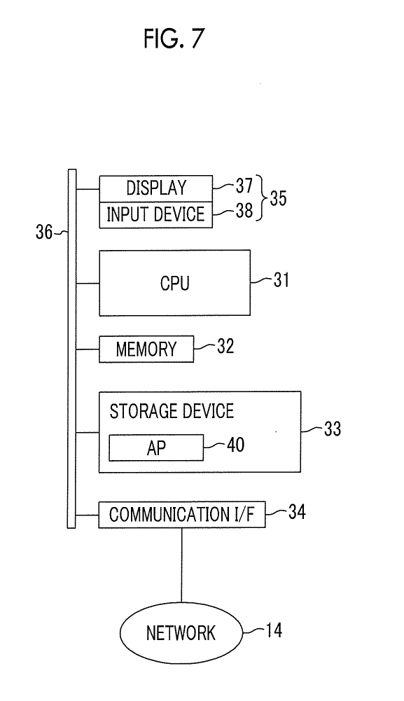

As shown in FIG. 7, computers that form the servers 11 and 15 to 17 and the client terminal 12 have basically the same configuration, and each computer includes a central processing unit (CPU) 31, a memory 32, a storage device 33, a communication I/F 34, and an input/output unit 35. These are connected to each other through a data bus 36. The input/output unit 35 is configured to include a display 37 and an input device 38, such as a keyboard or a mouse.

The storage device 33 that is a recording medium is, for example, a hard disk drive (HDD), and a control program or an application program (hereinafter, referred to as an AP) 40 is stored in the storage device 33. In each of the servers 11 and 15 to 17 in which a DB is provided, apart from the HDD to store a program, for example, a disk array formed by connecting a plurality of HDDs to each other is provided as the storage device 33 for DB. The disk array may be provided in the main body of each server, or may be provided separately from the main body of each server and be connected to the main body of the server through a network, such as a local area network (LAN).

The memory 32 is a work memory required when the CPU 31 executes processing, and is a random access memory (RAM). The CPU 31 performs overall control of each unit of the computer by loading the control program stored in the storage device 33 to the memory 32 and executing the processing according to the program. The communication I/F 34 is a network interface for transmission control through the network 14.

A client program is installed in the client terminal 12 as an AP 40. The client program is a program causing the client terminal 12 to execute a function of accessing the medical assistance server 11 to transmit various requests, such as a request for the viewing or editing of the medical assistance screen 21, or a function of receiving and displaying the medical assistance screen 21 transmitted to the client terminal 12 from the medical assistance server 11. The client program may be programmed for the exclusive use of the medical assistance system 10, or may be a known web browser.

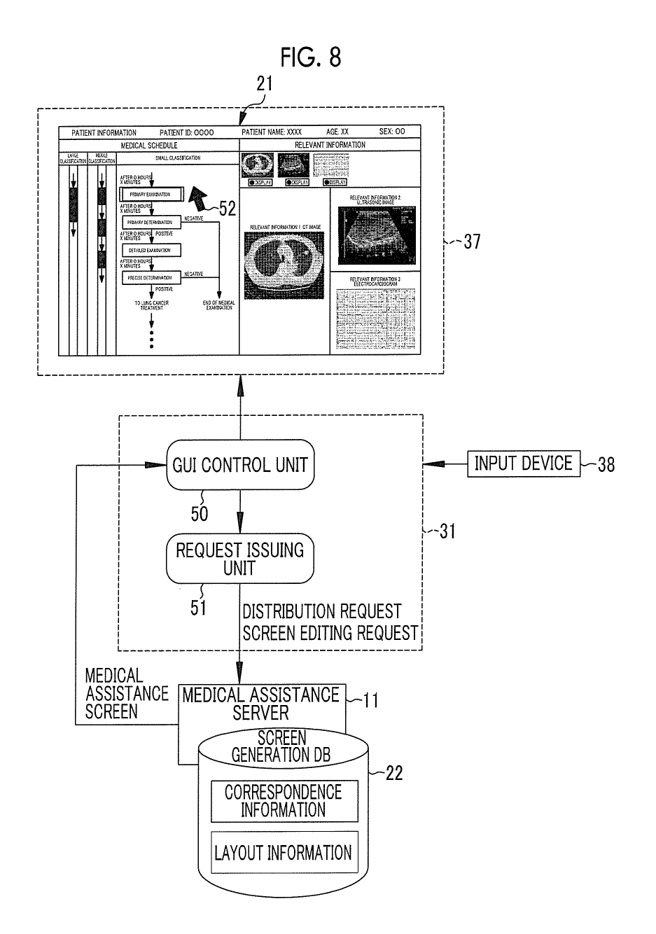

As shown in FIG. 8, when a client program is started, a startup screen with an operation function through a graphical user interface (GUI) is displayed on the display 37 of the client terminal 12, and the CPU 31 of the client terminal 12 cooperates with the memory 32 and the like to function as a GUI control unit 50 and a request issuing unit 51 that issues various requests to the medical assistance server 11. On the startup screen, the designation of a patient ID or an operation of issuing a request for the distribution of the medical assistance screen 21 is performed.

The medical assistance screen 21 is formed by data written in a markup language, such as Extensible Markup Language (XML). The medical assistance screen 21 itself also has an operation function through the GUI. The GUI control unit 50 receives an operation instruction from the input device 38 through the medical assistance screen 21, such as an operation button clicking operation using a pointer 52 of a mouse, and performs screen control according to the received operation instruction. An instruction to issue a distribution request or a screen editing request is input to the request issuing unit 51 through the GUI control unit 50. The request issuing unit 51 issues a request for the distribution of the medical assistance screen 21 of the designated patient ID or a screen editing request of the designated content according to the issuance instruction.

As shown in FIG. 9, the medical assistance screen 21 includes not only the medical schedule display region 21a and the relevant information display region 21b described above but also a patient information display region 21c. Patient information, that is, a patient ID and the name, age, and sex of the patient are displayed in the patient information display region 21c.

A medical schedule is displayed in the medical schedule display region 21a. As described above, the medical schedule is hierarchized into three levels of a large classification, a middle classification, and a small classification. The medical schedule display region 21a is divided into sub-regions to display the medical schedule of each classification. One of the three sub-regions is displayed in an enlarged manner. In the sub-region displayed in an enlarged manner, components of the medical schedule are displayed so as to be distinguishable. In the initial state, the sub-region of the medical schedule of the small classification is enlarged, so that the name of each medical act that is a component of the medical schedule of the small classification is displayed so as to be distinguishable. For medical schedules (in the initial state, medical schedules of the large classification and the middle classification) other than the enlarged sub-region, the name of each medical act is not displayed, and only the presence of the medical act is displayed so as to be distinguishable as shown by hatching.

When switching the sub-region to be displayed in an enlarged manner among the sub-regions, for example, the pointer 52 is made to overlap each sub-region to perform a clicking operation. Then, a screen editing request for the switching of the sub-region to be displayed in an enlarged manner is issued, and the screen editing request is transmitted from the client terminal 12 to the medical assistance server 11. The medical assistance server 11 edits the medical schedule display region 21a of the medical assistance screen 21 according to the issued request. Specifically, the medical assistance server 11 performs editing for the switching of the sub-region to be displayed in an enlarged manner in the medical schedule display region 21a, and distributes the edited screen data to the client terminal 12. As a result, in the client terminal 12, the medical schedule display region 21a where the sub-region that is displayed in an enlarged manner has been changed is displayed.

Relevant information that is relevant to the selected medical act, of the medical acts included in the medical schedule displayed in the medical schedule display region 21a, is displayed in the relevant information display region 21b. For the selected medical act, for example, a frame surrounding the name of the medical act is displayed by a thick frame so that the selected medical act can be distinguished from non-selected medical acts. Needless to say, the selected medical act can be distinguished from the other medical acts by performing hatching in a frame. In this example, “primary examination” is selected, and relevant information of “primary examination” is displayed in the relevant information display region 21b.

The selection of the medical act is performed by overlapping the pointer 52 on the name of the medical act and performing a clicking operation, for example. Then, a selection operation instruction to select the type of the medical act to display the relevant information is input, and a screen editing request based on the input selection operation instruction is issued. Then, the medical assistance server 11 edits the relevant information display region 21b of the medical assistance screen 21 according to the issued request.

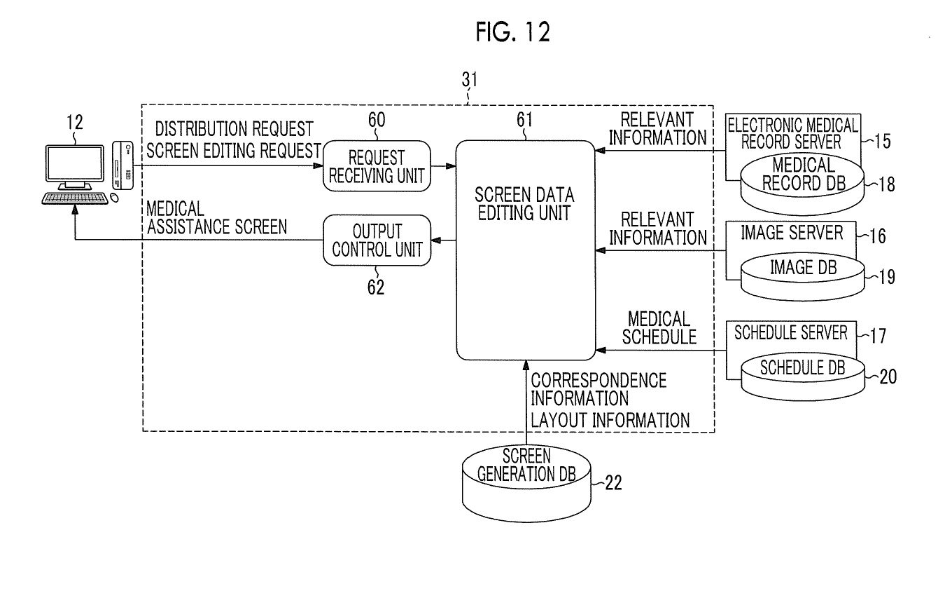

Thus, the relevant information of the medical act selected in the medical schedule display region 21a is displayed in the relevant information display region 21b. When a request for the distribution of the medical assistance screen 21 is first received from the client terminal 12, the medical assistance server 11 distributes the medical assistance screen 21 of the initial state. In the initial state of the medical assistance screen 21, the selection of the medical act by the user is not performed. In this case, a screen data editing unit 61 (refer to FIG. 12) of the medical assistance server 11 automatically selects a medical act set in advance, and generates the medical assistance screen 21 on which the automatically selected relevant information is displayed in the relevant information display region 21b. Here, the screen data editing unit 61 functions as an automatic selection unit of the invention. The medical act set in advance is, for example, a scheduled medical act to be performed in the nearest future or a medical act displayed in the uppermost portion of the enlarged sub-region of the medical schedule display region 21a.

As described above, each medical act and relevant information corresponding to each medical act are matched with each other by the correspondence relationship stored in the screen generation DB 22 (refer to FIG. 5). Layout information defines the position, size, and number to display the relevant information (refer to FIG. 6). Therefore, since the number of pieces of relevant information of the selected medical act is determined by the selection of the medical act, the layout is also selected automatically. For example, when the medical act A shown in FIG. 5 is selected, the number of pieces of relevant information of the medical act A is three of relevant information 1 to relevant information 3. Therefore, the layout 3 in which three pieces of relevant information can be displayed is automatically selected as a layout.

In this example, the medical act A shown in FIG. 5 and the “primary examination” shown in FIG. 9 are matched with each other. Therefore, in FIG. 9, in the relevant information display region 21b, a “CT image” is displayed as the relevant information 1, an “ultrasonic image” is displayed as the relevant information 2, and an “electrocardiogram” is displayed as the relevant information 3.

In the present embodiment, a thumbnail image display region 21d is provided in the relevant information display region 21b. A thumbnail image with reduced relevant information of the selected medical act is displayed in thumbnail image display region 21d. In the thumbnail image display region 21d, a designation tag 21e for designating whether or not to display relevant information corresponding to each thumbnail image is provided below each thumbnail image. By clicking the designation tag 21e with the pointer 52, it is possible to perform switching regarding whether or not to display relevant information corresponding to each thumbnail image.

Thus, since the relevant information of the selected medical act of the medical acts included in the medical schedule displayed in the medical schedule display region 21a is displayed in the relevant information display region 21b, the user (for example, a medical staff member, such as a doctor, a nurse, or a laboratory technician) of the client terminal 12 can perform the medical examination based on the medical assistance screen 21 while referring to both the medical schedule and the relevant information.

In the example shown in FIG. 9, “primary examination” corresponding to the medical act A shown in FIG. 5 is selected, and three pieces of relevant information of the relevant information 1 (CT image), the relevant information 2 (ultrasonic image), and the relevant information 3 (electrocardiogram) are displayed in the layout 3 (refer to FIG. 6). However, needless to say, the display content of the relevant information display region 21b changes according to the selected medical act.

For example, as shown in FIG. 10, when the medical act B (refer to FIG. 5) is selected, the relevant information 1 (CT image), the relevant information 2 (ultrasonic image), the relevant information 3 (result of the blood test), and the relevant information 4 (electrocardiogram) are displayed in the layout 4 (display layout used when the number of pieces of relevant information is four (refer to FIG. 6)).

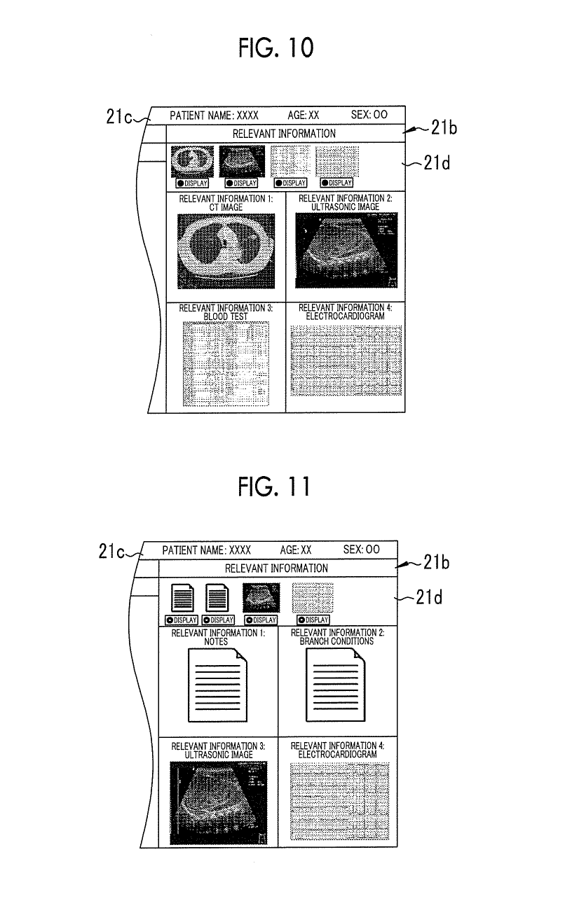

In addition, as shown in FIG. 11, when the medical act C (refer to FIG. 5) is selected, the relevant information 1 (notes), the relevant information 2 (branching conditions), the relevant information 3 (ultrasonic image), and the relevant information 4 (electrocardiogram) are displayed in the layout 4. In FIG. 11, for the relevant information 1 (notes) and the relevant information 2 (branching conditions), there is a shortcut button for accessing the storage destination (access destination) of document data. By clicking the shortcut button with the pointer 52 in a state in which the pointer 52 overlaps the shortcut button, corresponding text data is displayed.

As shown in FIG. 12, in the medical assistance server 11, a server program is installed as the AP 40. When the server program is started, the CPU 31 of the medical assistance server 11 cooperates with the memory 32 and the like to function as a request receiving unit 60, the screen data editing unit 61, and an output control unit 62.

The request receiving unit 60 receives a request based on various operations performed in the client terminal 12, that is, a request for the distribution of the medical assistance screen 21 or a request for the screen editing of the medical assistance screen 21. When the distribution request or the screen editing request is received, the request receiving unit 60 inputs the received request to the screen data editing unit 61. In the screen editing request that is input as described above, a screen editing request based on the selection operation instruction to select one medical act from a plurality of medical acts included in the medical schedule in the medical schedule display region 21a is also included. That is, the request receiving unit 60 is an operation instruction receiving unit of the invention.

The screen data editing unit 61 acquires a medical schedule regarding a patient ID, which is designated by the distribution request input from the client terminal 12, from the schedule DB 20. For a medical act selected by the distribution request or the screen editing request that is input from the client terminal 12, the screen data editing unit 61 accesses the screen generation DB 22 to read correspondence information between the medical act and the relevant information. Since the correspondence information indicates a correspondence relationship between the medical act and the relevant information, the screen data editing unit 61 functions as a correspondence relationship reading unit of the invention.

Then, the screen data editing unit 61 determines the relevant information of the selected medical act from the read correspondence information, and acquires the determined relevant information from the medical record DB 18 or the image DB 19. In addition, the screen data editing unit 61 acquires the layout corresponding to the number of acquired pieces of relevant information from the screen generation DB 22. Then, the screen data editing unit 61 performs editing to display the acquired relevant information in the relevant information display region 21b of the medical assistance screen 21. As a result, relevant information corresponding to the selected medical act is displayed in the relevant information display region 21b.

The output control unit 62 performs processing for distributing the medical assistance screen 21 generated by the screen data editing unit 61 to the requesting client terminal 12. The client terminal 12 displays the received medical assistance screen 21 on its own display 37.

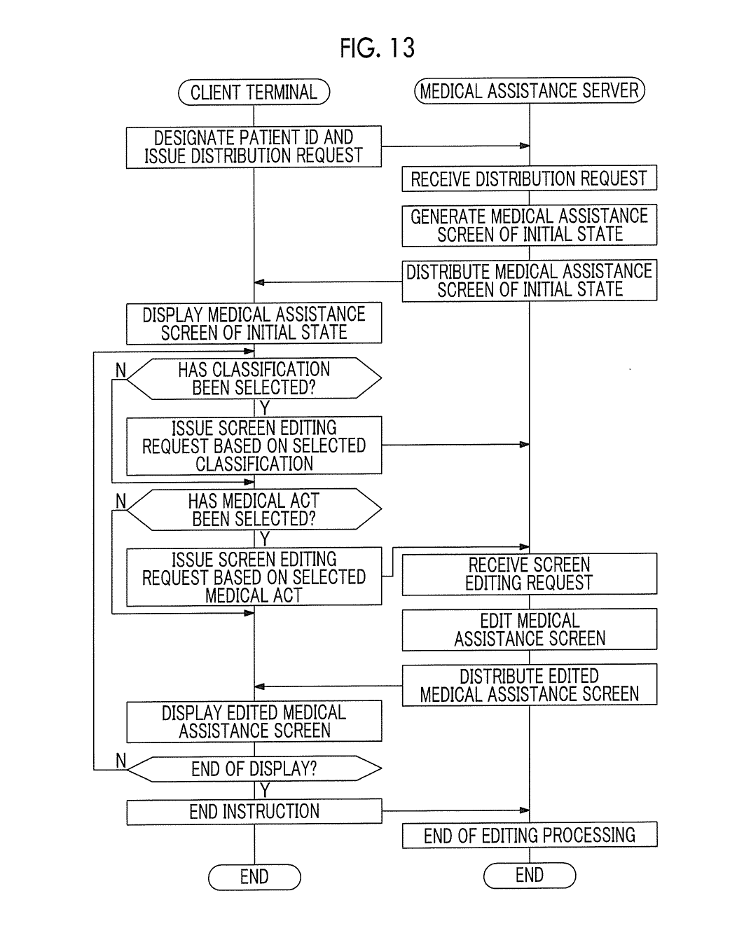

Hereinafter, the operation of the invention by the above configuration will be described with reference to FIG. 13. When displaying the medical assistance screen 21, a client program is started in the client terminal 12, and patient ID is designated. Then, a request for the distribution of the medical assistance screen 21 is issued in the client terminal 12, and is input to the medical assistance server 11. In response to the distribution request, the medical assistance server 11 generates the medical assistance screen 21 of the initial state and distributes it to the client terminal 12. In the client terminal 12, the medical assistance screen 21 of the initial state that has been distributed as described above is displayed on the display.

On the medical assistance screen 21 of the initial state, a sub-region of the medical schedule of a classification set in advance, for example, a small classification, is displayed in an enlarged manner in the medical schedule display region 21a (refer to FIG. 9). In addition, on the medical assistance screen 21 of the initial state, relevant information of the medical act (for example, a medical act displayed in the uppermost portion of the sub-region displayed in an enlarged manner) that is automatically selected among the medical acts included in the medical schedule of the small classification is displayed in the relevant information display region 21b according to the layout corresponding to the number of pieces of relevant information (refer to FIG. 9).

In the client terminal 12, for the medical assistance screen 21 of the initial state displayed as described above, it is possible to select which of the sub-regions where the medical schedule of each classification is displayed is to be displayed in an enlarged manner. This selection is performed by making the pointer 52 overlap a sub-region to be enlarged and performing a clicking operation, and a screen editing request for the enlarged display of the sub-region selected by the operation is input to the medical assistance server 11.

When the request is received, the medical assistance server 11 edits the selected sub-region so as to be displayed in an enlarged manner based on the request, and distributes the edited medical assistance screen 21 to the client terminal 12. In the client terminal 12, the medical assistance screen 21 that has been edited as described above is updated and displayed on the display 37.

In the client terminal 12, it is possible to perform a selection operation to select one of the medical acts in the sub-region that is displayed in an enlarged manner in the medical assistance screen 21. This selection operation is performed by clicking the name of the medical act with the pointer 52 in a sub-region where the medical act to be selected is displayed, and a screen editing request for the display of relevant information corresponding to the medical act selected by the selection operation in the relevant information display region 21b is transmitted to the medical assistance server 11.

When the request is received, the medical assistance server 11 edits the display content of the relevant information display region 21b based on the request. Specifically, relevant information of the selected medical act is acquired from the medical record DB 18 or the image DB 19, and the layout corresponding to the number of pieces of relevant information is acquired from the screen generation DB 22. The relevant information display region 21b is edited based on the acquired layout and relevant information, and the edited medical assistance screen 21 is distributed to the client terminal 12. In the client terminal 12, the medical assistance screen 21 that has been edited as described above is updated and displayed on the display 37. Therefore, it is possible to view the medical schedule and the relevant information of the selected medical act in the medical schedule.

The editing of the medical assistance screen 21 based on the classification or the selection of the medical act is continued until the display of the medical assistance screen 21 ends in the client terminal 12. When the display of the medical assistance screen 21 ends in the client terminal 12, an end instruction is input to the medical assistance server 11 from the client terminal 12. In response to the end designation, the medical assistance server 11 ends the editing processing of the medical assistance screen 21.

As described above, according to the medical assistance system 10 of the present embodiment, a medical schedule and relevant information, which is relevant to the selected medical act of the medical acts included in the medical schedule, are displayed on one medical assistance screen. Therefore, it is possible to easily refer to the relevant information at the same time as the viewing of the medical schedule. In the related art, since no relevant information is displayed on the display screen of the medical schedule, time and effort to collect the relevant information has been required. According to the present embodiment, however, compared with such a related art, it is possible to easily provide a more extensive medical assistance.

### Second Embodiment

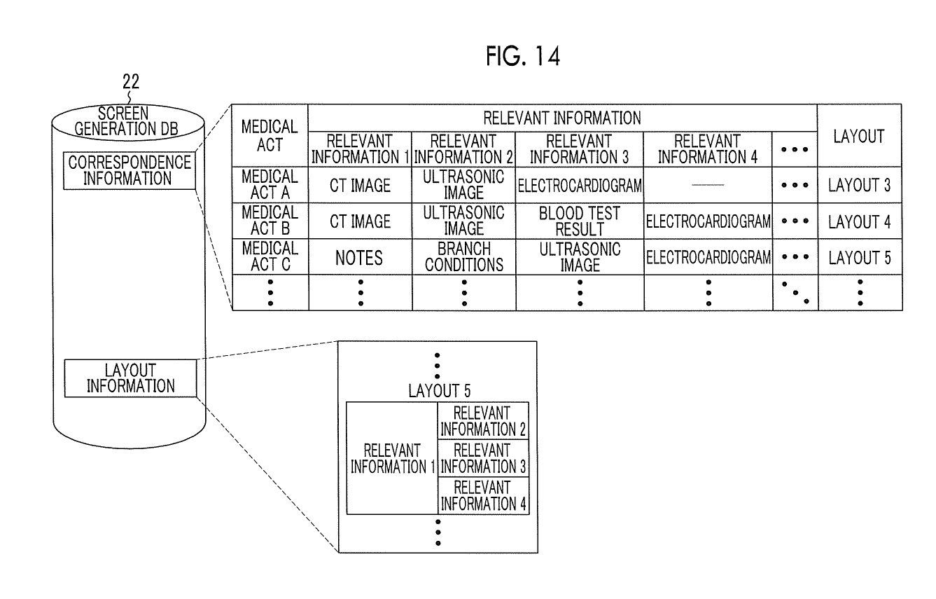

Next, a second embodiment of the invention will be described with reference to FIG. 14. In addition, in the second and subsequent embodiments, the same components as described above are denoted by the same reference numerals, and explanation thereof will be omitted.

In the first embodiment, the layout for displaying relevant information is selected according to the number of pieces of relevant information of the selected medical act. In the first embodiment, it is assumed that one layout is determined uniquely according to the number of pieces of relevant information. However, needless to say, there is a plurality of layouts in which the same number of pieces of relevant information can be displayed but the display position or the display size is different. Which one of the plurality of layouts is preferable also changes according to the type of relevant information. Therefore, it is preferable to select the layout in consideration of not only the number of pieces of relevant information but also the type of relevant information. The second embodiment is an example in which the layout is selected according to the number of pieces and type of relevant information.

As shown in FIG. 14, in the second embodiment, not only is the relevant information matched with the medical act, but also the layout to display the relevant information is matched with the medical act. Therefore, it is possible to select the layout according to the number of pieces and type of relevant information of the medical act. In FIG. 14, layouts 3 to 5 are matched with the medical acts A to C, respectively. The layout 5 is a layout in which the relevant information display region 21b is divided into two left and right regions, the relevant information 1 is displayed in the left region, the right region is divided into three regions in a vertical direction, and the relevant information 2, 3, and 4 is displayed in order from the upper region.

Thus, in the second embodiment, it is possible to change the layout for the medical acts B and C each having, for example, four pieces of relevant information by matching the medical act and the layout with each other. Therefore, compared with the first embodiment, it is possible to display the relevant information based on the layout that is more suitable for the type of medical act.

### Third Embodiment

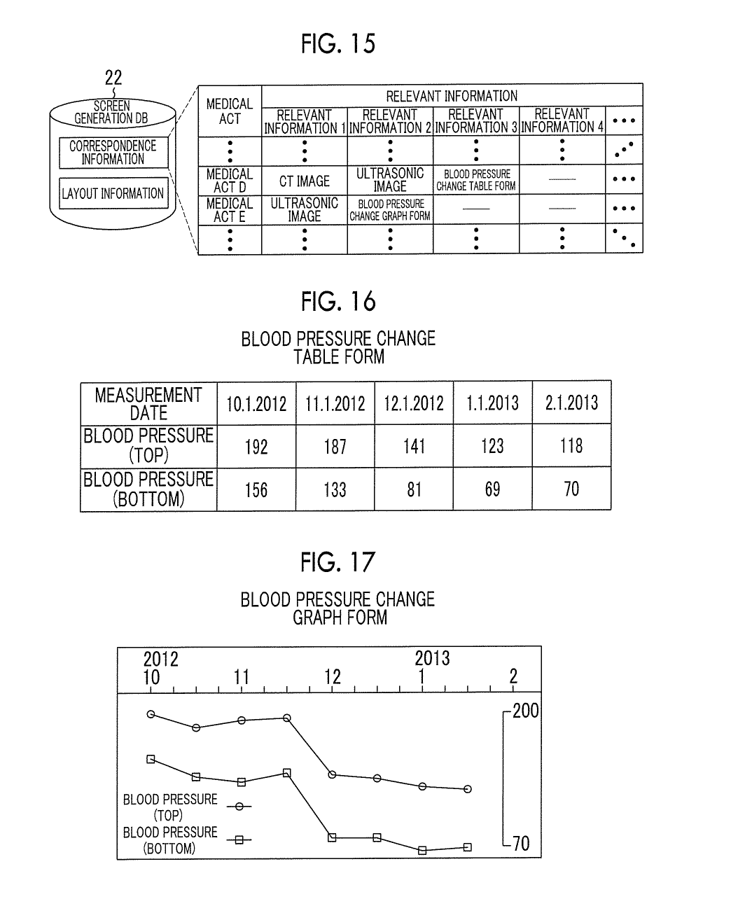

Next, a third embodiment of the invention will be described with reference to FIGS. 15 to 17. As shown in FIG. 15, in the third embodiment, the correspondence relationship between medical acts D and E and relevant information that is relevant to the medical acts D and E is stored as correspondence information. For the medical act D, “CT image”, “ultrasonic image”, and “blood pressure change (table form)” are matched as relevant information 1, relevant information 2, and relevant information 3, respectively. For the medical act E, “ultrasonic image” and “blood pressure change (graph form)” are matched as relevant information 1 and relevant information 2, respectively.

In the third embodiment, “blood pressure change” that is the relevant information 3 of the medical act D and “blood pressure change” that is the relevant information 2 of the medical act E show the information of the same “blood pressure change”. On the other hand, the display form of “blood pressure change” of the medical act D is different from that of the medical act E. That is, “blood pressure change” of the medical act D is displayed in a table form as shown in FIG. 16, and “blood pressure change” of the medical act E is displayed in a graph (figure) form as shown in FIG. 17. As in the third embodiment, the display form of the relevant information of the same type may also be changed depending on the type of medical act. In addition, the display form of the relevant information of the same type is not limited to the table and the graph (figure) described above, and the relevant information can be displayed in various display forms including characters, numbers, images, and the like. Needless to say, when the relevant information is displayed in a display form including an image, this image is not limited to a still image, and may be a moving image. The relevant information may be voice data. In addition, when the relevant information is a moving image or voice data, it is preferable to display a link tag for reproducing the moving image or the voice data in a relevant information display region.

In addition, the invention is not limited to the embodiments described above, and the detailed configuration of the medical assistance screen 21 can be appropriately changed. For example, the type or number of pieces of relevant information displayed on the medical assistance screen 21 and the correspondence relationship between the medical act and the relevant information are not limited to the embodiments described above, but can be appropriately changed. For example, relevant information may not be examination data of a patient obtained by examination, such as an examination image or a blood pressure change. As relevant information other than examination data, a memo or conversations among the medical staff (for example, doctors, nurses, and laboratory technicians) performed during the medical act or after the medical act may be stored as informative matter or conversation records. This may be set as relevant information. The conversation record also includes a record of a chat performed between client terminals through a network. When displaying the conversation record, such as a chat, as relevant information, it is preferable to display the content of the conversation in time series. Needless to say, relevant information is not limited to the above examples since the relevant information may be information referred to when performing the medical act for a patient, and various kinds of information, such as an examination result or a text obtained from the medical acts up to the present, can be displayed in the relevant information display region as relevant information. In addition, as described above, the relevant information can be displayed in various display forms, such as a table, a graph (figure), characters, numbers, images (still images and moving images), voice, and a link tag for reproducing an image or a voice.

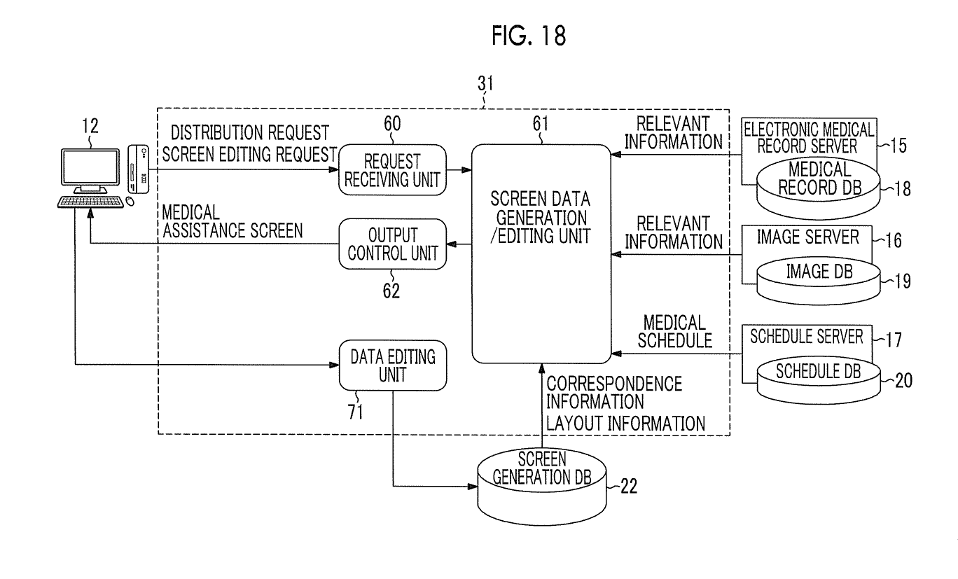

The content of the screen generation DB 22, such as correspondence information or layout information, may be configured so as to be able to be edited, so that the user can freely edit the correspondence relationship between the medical act and the relevant information or the layout. In this case, as shown in FIG. 18, the CPU 31 of the medical assistance server 11 functions as a data editing unit 71 that edits the data in the screen generation DB 22.

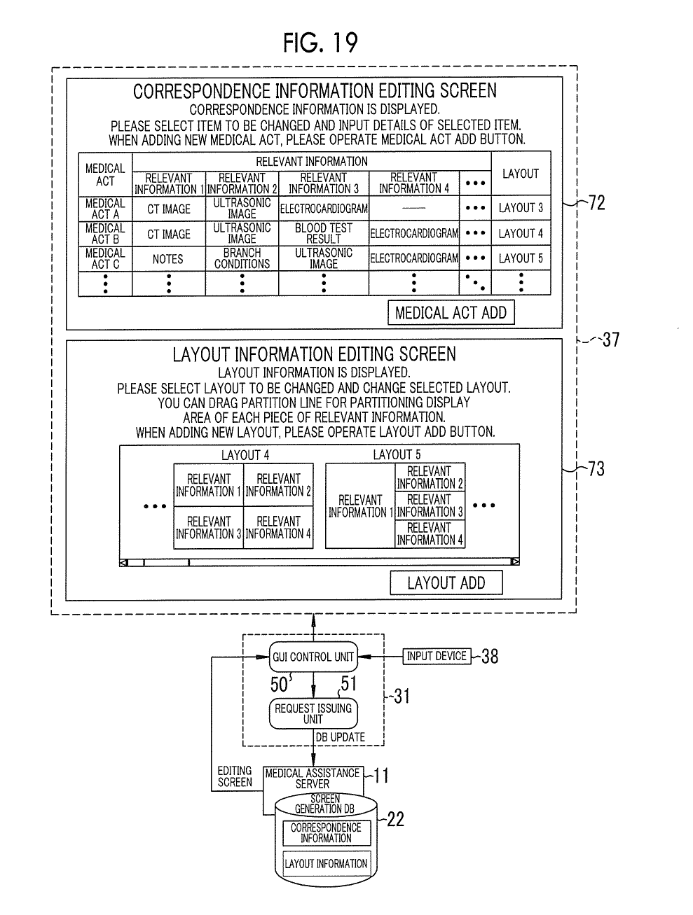

As shown in FIG. 19, in response to the request from the client terminal 12, the data editing unit 71 distributes an edit screen for editing the content of the screen generation DB 22, such as an edit screen 72 for editing the correspondence information or an edit screen 73 for editing the layout information, for example. In the client terminal 12, the edit screens 72 and 73 are displayed, and the user performs an editing operation through the edit screens 72 and 73. A data editing request is transmitted to the medical assistance server 11 based on the editing operation, and the data editing unit 71 changes the content (for example, correspondence information or layout information) of the screen generation DB 22 based on the received data editing request. In this manner, it is possible to change the display mode including the type, number of pieces, and layout of relevant information according to user preferences.

In the above embodiment, a client-server system that distributes the medical assistance screen 21 from the medical assistance server 11 to the client terminal 12 through the network has been described as an example. In this example, the medical assistance server 11 corresponds to a medical assistance device. However, the invention is not limited to the client-server system, and the client terminal 12 itself may be configured as a medical assistance device. In this case, the CPU 31 of the client terminal 12 functions as the request receiving unit 60, the screen data editing unit 61, and the output control unit 62. In addition, the request receiving unit 60 functions as an operation instruction receiving unit that receives an operation instruction from the input device 38 of the client terminal 12. The output control unit 62 performs control to output the medical assistance screen 21, which is generated and/or edited by the screen data editing unit 61, to the display 37. That is, in the client-server system, the output control unit 62 controls the distribution output from the medical assistance server 11 to the client terminal 12. However, when the client terminal 12 itself is configured as a medical assistance device, display output to the display 37 is controlled.

The invention is not limited to the above embodiments or modifications, and various configurations can be adopted without departing from the scope of the invention. For example, it is also possible to appropriately combine the above embodiments or modifications. The invention extends not only to a program but also to a storage medium for storing a program.

What is claimed is:

1. A medical assistance device, comprising:
an output control unit that outputs a medical assistance screen including a medical schedule display region, in which a medical schedule that is plurality of medical acts performed on a patient are arranged along a time axis is displayed, and a relevant information display region, in which relevant information that is relevant to the medical acts is displayed;
an operation instruction receiving unit that receives a selection operation instruction to select one of the plurality of medical acts included in the medical schedule in the medical schedule display region;
a correspondence relationship reading unit that accesses a storage unit, in which a correspondence relationship between each of the plurality of medical acts and relevant information corresponding to each medical act is stored, to read a correspondence relationship regarding a medical act selected by the selection operation instruction; and
a screen data editing unit that acquires the relevant information of the selected medical act based on the correspondence relationship read by the correspondence relationship reading unit and displays the acquired relevant information in the relevant information display region.

2. The medical assistance device according to claim 1,
wherein the relevant information includes at least either vital information of a patient or attention information to be noted when performing each of the medical acts.

3. The medical assistance device according to claim 2,
wherein the attention information includes at least either notes when performing each of the medical acts or branching conditions when a route of the medical schedule branches.

4. The medical assistance device according to claim 1, further comprising:
an automatic selection unit that automatically selects one of the medical acts in the medical schedule when there is no input of the selection operation instruction,
wherein the correspondence relationship reading unit reads the correspondence relationship regarding the medical act selected by the automatic selection unit.

5. The medical assistance device according to claim 2, further comprising:
an automatic selection unit that automatically selects one of the medical acts in the medical schedule when there is no input of the selection operation instruction,
wherein the correspondence relationship reading unit reads the correspondence relationship regarding the medical act selected by the automatic selection unit.

6. The medical assistance device according to claim 3, further comprising:
an automatic selection unit that automatically selects one of the medical acts in the medical schedule when there is no input of the selection operation instruction,
wherein the correspondence relationship reading unit reads the correspondence relationship regarding the medical act selected by the automatic selection unit.

7. The medical assistance device according to claim 1, further comprising:
a data editing unit that edits the correspondence relationship stored in the storage unit based on a data editing request.

8. The medical assistance device according to claim 2, further comprising:
a data editing unit that edits the correspondence relationship stored in the storage unit based on a data editing request.

9. The medical assistance device according to claim 3, further comprising:
a data editing unit that edits the correspondence relationship stored in the storage unit based on a data editing request.

10. The medical assistance device according to claim 4, further comprising:
a data editing unit that edits the correspondence relationship stored in the storage unit based on a data editing request.

11. The medical assistance device according to claim 1,
wherein not only the correspondence relationship but also a layout for displaying the relevant information in the relevant information display region is stored in the storage unit, and
the screen data editing unit edits the relevant information display region based on the correspondence relationship and the layout.

12. The medical assistance device according to claim 2,
wherein not only the correspondence relationship but also a layout for displaying the relevant information in the relevant information display region is stored in the storage unit, and
the screen data editing unit edits the relevant information display region based on the correspondence relationship and the layout.

13. The medical assistance device according to claim 3,
wherein not only the correspondence relationship but also a layout for displaying the relevant information in the relevant information display region is stored in the storage unit, and
the screen data editing unit edits the relevant information display region based on the correspondence relationship and the layout.

14. The medical assistance device according to claim 4,
wherein not only the correspondence relationship but also a layout for displaying the relevant information in the relevant information display region is stored in the storage unit, and
the screen data editing unit edits the relevant information display region based on the correspondence relationship and the layout.

15. The medical assistance device according to claim 1,
wherein, as a display form of the relevant information, at least one of characters, numbers, a still image, a moving image, a graph, and a table is included.

16. The medical assistance device according to claim 2,
wherein, as a display form of the relevant information, at least one of characters, numbers, a still image, a moving image, a graph, and a table is included.

17. The medical assistance device according to claim 3,
wherein, as a display form of the relevant information, at least one of characters, numbers, a still image, a moving image, a graph, and a table is included.

18. A medical assistance system, comprising:
a client terminal; and
a medical assistance device that assists a medical act based on a request input from the client terminal,
wherein the medical assistance device includes:
an output control unit that outputs a medical assistance screen including a medical schedule display region, in which a medical schedule that is plurality of medical acts performed on a patient are arranged along a time axis is displayed, and a relevant information display region, in which relevant information that is relevant to the medical acts is;
an operation instruction receiving unit that receives a selection operation instruction to select one of the plurality of medical acts included in the medical schedule in the medical schedule display region;
a correspondence relationship reading unit that accesses a storage unit, in which a correspondence relationship between each of the plurality of medical acts and relevant information corresponding to each medical act is stored, to read a correspondence relationship regarding a medical act selected by the selection operation instruction; and
a screen data editing unit that acquires the relevant information of the selected medical act based on the correspondence relationship read by the correspondence relationship reading unit and displays the acquired relevant information in the relevant information display region.

19. A non-transitory computer-readable recording medium on which a medical assistance program is recorded,
wherein the program causes a computer as a medical assistance device for assisting a medical act to execute:
an output control step that outputs a medical assistance screen including a medical schedule display region, in which a medical schedule that is plurality of medical acts performed on a patient are arranged along a time axis is displayed, and a relevant information display region, in which relevant information that is relevant to the medical acts is displayed;
an operation instruction receiving step that receives a selection operation instruction to select one of the plurality of medical acts included in the medical schedule in the medical schedule display region;
a correspondence relationship reading step that accesses a storage unit, in which a correspondence relationship between each of the plurality of medical acts and relevant information corresponding to each medical act is stored, to read a correspondence relationship regarding a medical act selected by the selection operation instruction; and
a screen data editing step that acquires the relevant information of the selected medical act based on the correspondence relationship read in the correspondence relationship reading step and displaying the acquired relevant information in the relevant information display region.

20. A medical assistance method, comprising:
an output control step that outputs a medical assistance screen including a medical schedule display region, in which a medical schedule that is plurality of medical acts performed on a patient are arranged along a time axis is displayed, and a relevant information display region, in which relevant information that is relevant to the medical acts is displayed;
an operation instruction receiving step that receives a selection operation instruction to select one of the plurality of medical acts included in the medical schedule in the medical schedule display region;
a correspondence relationship reading step that accesses a storage unit, in which a correspondence relationship between each of the plurality of medical acts and relevant information corresponding to each medical act is stored, to read a correspondence relationship regarding a medical act selected by the selection operation instruction; and
a screen data editing step that acquires the relevant information of the selected medical act based on the correspondence relationship read in the correspondence relationship reading step and displaying the acquired relevant information in the relevant information display region,
wherein all of the above steps are executed by a medical assistance device using a computer.
